(19) United States
(12) Patent Application Publication
(10) Pub. No.: US 2008/0092634 A1
(43) Pub. Date: Apr. 24, 2008

(54) Storage Tank Leak Monitoring and Venting Apparatus

(76) Inventors: Eric Bourassa, Cowansville (CA); Jacques C. LaCroix, Orford (CA); Yves Legault, Sherbrooke (CA); Sylvain Ruel, Roxton Pond (CA)

Correspondence Address: BRADLEY ARANT ROSE & WHITE, LLP;INTELLECTUAL PROPERTY DEPARTMENT-NWJ, 1819 FIFTH AVENUE NORTH, BIRMINGHAM, AL, 35203-2104, US

(21) Appl. No.: 11/780,866

(22) Filed: Jul. 20, 2007

Related U.S. Application Data
(60) Provisional application No. 60/832,150, filed on Jul. 21, 2006.

(51) Int. Cl. G01M 3/04

(52) U.S. Cl. 73/49.2

(57) ABSTRACT

A leak monitoring and emergency venting apparatus for a double-walled tank includes a pipe for connecting a space between the walls of the tank to the atmosphere, a plug releasably closing an outer end of the pipe, and a pressure gauge in the plug in fluid communication with the interior of the pipe for monitoring the fluid pressure between the walls of the tank. If the pressure in the space between the walls of the tank rises above a predetermined level, the plug and gauge are discharged from the pipe allowing venting of the space to the atmosphere.

This application claims the benefit of and priority from U.S. Provisional Patent Application Ser. No. 60/832,150 filed on Jul. 21, 2006 which is hereby incorporated by reference.

### BACKGROUND OF THE INVENTION

1. Field of the Invention

This invention relates to a leak monitoring and emergency venting apparatus for use in a double-walled tank, and to a tank containing such an apparatus.

2. Description of Related Art

Leakage can be a serious problem with storage tanks, particularly when the tanks are used to store liquids such as heating oil, gasoline or diesel fuel. A relatively recent solution to the problem of leakage is the use of double-walled tanks. If a leak occurs in an inner tank wall, fluid escapes into an area between the walls of the tank. US Patent Publication No. 2006/0118563 (Travis et al) describes a storage tank including a plate or outer shell sealed to the bottom wall of a tank for containing any leakage from the bottom wall. The publication also teaches the use of a monitor pipe in fluid communication with the space between the bottom wall of the tank and the shell, whereby fluid escaping from the tank into such space can be monitored from outside the tank using a sensor in the pipe.

While the Travis et al publication suggests the use of a monitor including a sensor for sensing tank leakage into the space between the tank and an outer shell, Travis et al do not describe either a specific sensor or means for venting of the space between the tank and the shell in the event of an emergency, i.e. pressure build-up between the walls, e.g. in the event of fire.

The object of the prevent invention is to provide an apparatus for monitoring the area between the walls of a double walled tank to detect leaks, and for venting the area in the event of fluid pressure build-up in such area.

### BRIEF SUMMARY OF THE INVENTION

Accordingly, the invention relates to a leak monitoring and emergency venting apparatus for use in a tank including a shell covering at least a bottom of the tank, and a space between the tank and the shell for receiving fluid in the event of a tank leak comprising a pipe having one end in fluid communication with the space between the tank and the shell and a second end for venting to the atmosphere; a plug releasably sealed in the second end of the pipe, whereby when fluid pressure in said space rises above a predetermined level, the plug is ejected from the pipe to permit venting of the fluid to the atmosphere; and a pressure gauge in said plug in fluid communication with the pipe for providing an indication of fluid pressure in said space between the tank and the plug.

It will be appreciated that by double-walled tank is meant a tank including two full walls or, as in the case of the Travis et al apparatus, a single-walled tank having a plate or shell sealed to at least the bottom thereof for trapping fluid escaping from the tank bottom.

### BRIEF DESCRIPTION OF THE DRAWINGS

The invention is described below in greater detail with reference to the accompanying drawings, which illustrate a preferred embodiment of the invention, and wherein:

FIG. 1 is a partly sectioned isometric view of a double-walled tank incorporating an apparatus in accordance with the present invention.

FIG. 2 is a cross-sectional view of the tank of FIG. 1;

FIG. 3 is a longitudinal sectional view of the tank of FIG. 1;

FIG. 4 is a sectional view of a bottom corner of the tank and the apparatus of FIG. 1; and

FIG. 5 is a sectional view of a top corner of the tank and the apparatus of FIG. 1.

### DETAILED DESCRIPTION OF THE INVENTION

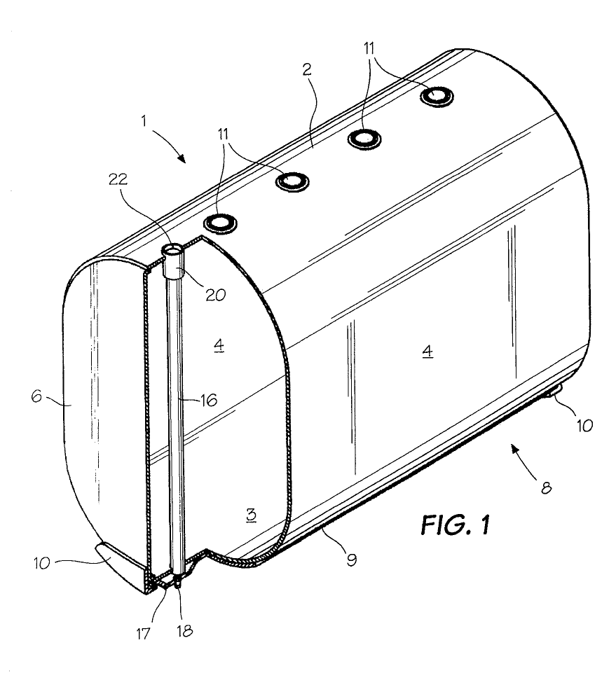

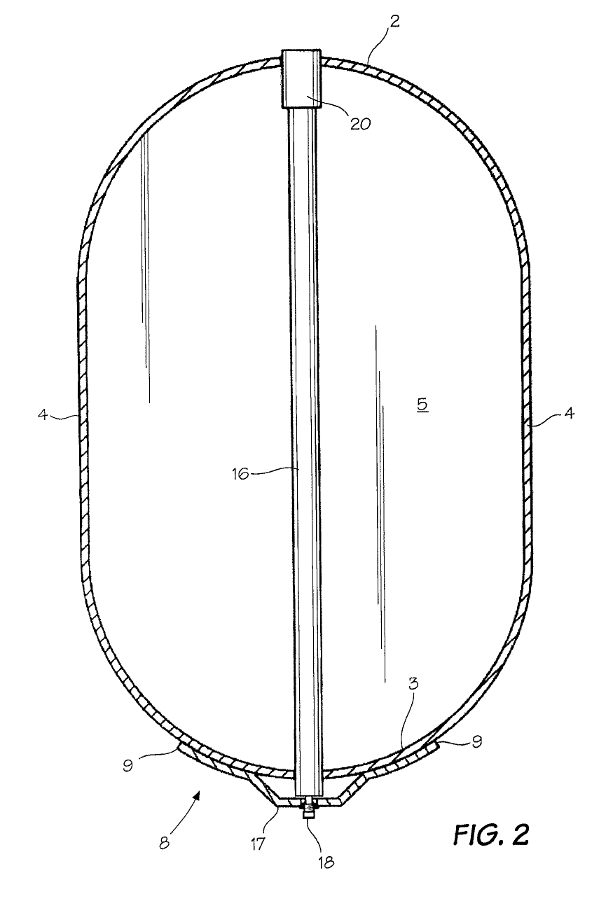

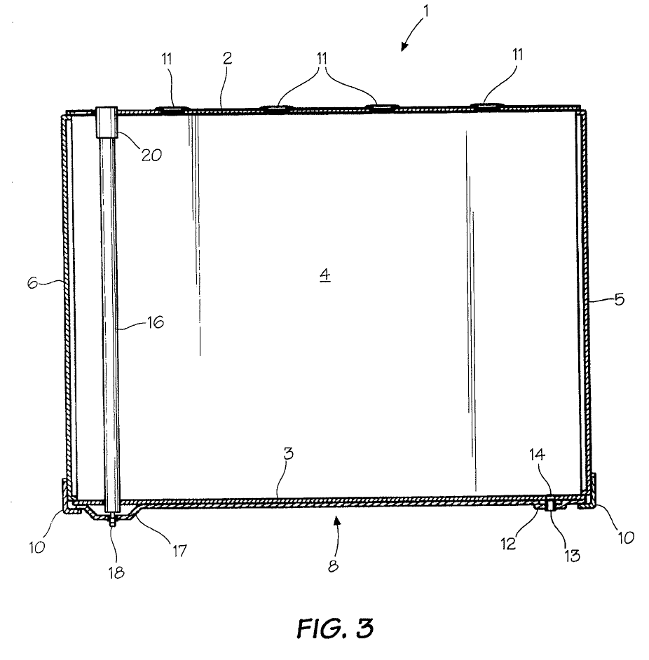

With reference to FIGS. 1 to 3, a tank indicated generally at 1 incorporating the apparatus of the present invention includes generally semi-cylindrical top and bottom walls 2 and 3, respectively, side walls 4, end walls 5 and 6, and a shell indicated generally at 8 sealed at its side edges 9 to the tank 1. The ends of the shell 8 are connected to the tank 1 by arcuate brackets 10 of L-shaped cross-section. The edges of the brackets 10 are welded to the bottom wall 3 and the end walls 5 and 6 of the tank 1. The top wall 2 of the tank 1 includes a plurality of circular ports closed by covers 11 permitting access to the tank. A shallow well 12 near one end of the shell 8 contains a removable plug 13 closing an opening 14 in the bottom wall 3 for draining the tank 1.

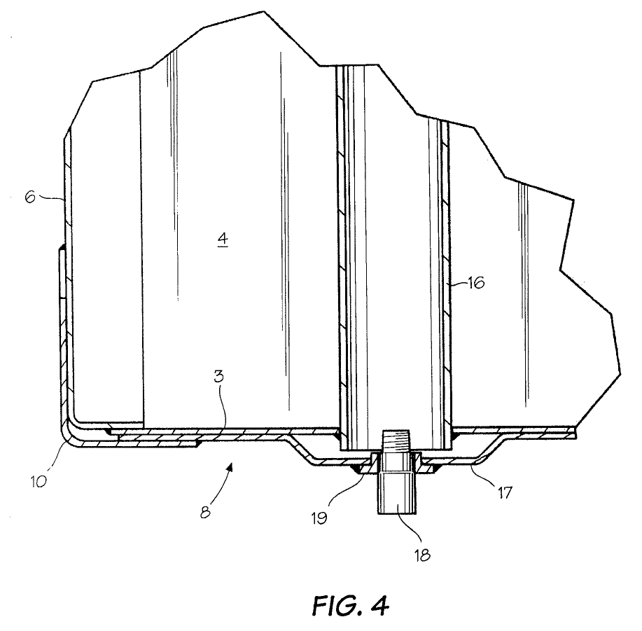

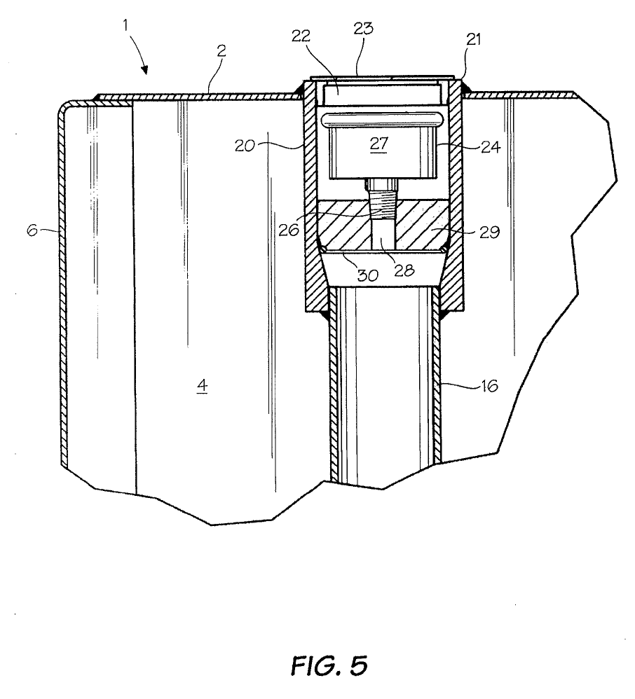

The apparatus of the present invention includes an elongated pipe 16 extending upwardly from a bowl-shaped well 17 in the shell 8 through the bottom wall 3 to a location proximate the top wall 2 of the tank 1. While the pipe 16 is shown as extending through the tank 1 near one end 6 thereof, the pipe could extend outwardly form the well 14, i.e. be external. As best shown in FIG. 4, a plug 18 closes a port in a collar 19 in the bottom center of the well 17, so that liquid can be drained from the pipe 16 and the well 17. A sleeve 20 (FIG. 5) welded to the top end of the pipe 16 extends upwardly through and is welded to the top wall 2 of the tank 1. The top end 21 of the sleeve 20 is closed by a cap 22 with a window 23 therein permitting viewing of a pressure gauge 24 in the sleeve 20. The externally threaded, tubular stem 26 of the gauge 24 extends downwardly from the cylindrical body 27 into a threaded passage 28 in a disc-shaped plug 29. The plug 29 is releasably sealed in the sleeve 18 by an O-ring 30.

A vacuum normally exists between the tank 1 and the shell 8. The vacuum tends to hold the pressure gauge 24 and the plug 29 fixed in the sleeve 20. In the event of a leak in the bottom 3 of the tank 1, the pressure in the space between the tank and the shell 8 will rise. The change in pressure can be seen on the gauge 24. If the pressure between the tank 1 and the shell 8 rises sufficiently, e.g. in the event of a fire, the plug 29, the gauge 24 and the cap 22 are blown out of the top end 21 of the sleeve 20, permitting venting of the space between the tank 1 and the shell 8.

It will be appreciated that the apparatus described above can be built into new tanks or retrofitted to existing single or double-walled tanks. It would be a relatively simple matter to modify an existing single-walled tank to convert it into a double-walled tank incorporating the apparatus of the present invention.

We claim:

1. A leak monitoring and emergency venting apparatus for use in a tank including a shell covering at least a bottom of the tank, and a space between the tank and the shell for receiving fluid in the event of a tank leak comprising a pipe having one end in fluid communication with the space between the tank and the shell and a second end for venting to the atmosphere; a plug releasably sealed in the second end of the pipe, whereby when fluid pressure in said space rises above a predetermined level, the plug is ejected from the pipe to permit venting of the fluid to the atmosphere; and a pressure gauge in said plug in fluid communication with the pipe for providing an indication of fluid pressure in said space between the tank and the plug.

2. The monitoring and venting apparatus of claim 1 including a sleeve on the second end of said pipe carrying said plug and said gauge.

3. The monitoring and venting apparatus of claim 2 including a cover on said sleeve, and a window in said cover for viewing the gauge.

4. A fluid storage tank comprising a top wall; a bottom wall; side walls; end walls; a shell covering at least said bottom wall with a space between said bottom wall for receiving fluid in the event of a tank lead; a pipe having one end in fluid communication with the space between the tank and the shell and a second end for venting to the atmosphere; a plug releasably sealed in the second end of the pipe, whereby when fluid pressure in said space rises above a predetermined level, the plug is ejected from the pipe to permit venting of the fluid to the atmosphere; and a pressure gauge in said plug in fluid communication with the pipe for providing an indication of fluid pressure in said space between the tank and the plug.

5. The storage tank of claim 4 including a sleeve on the second end of said pipe carrying said plug and said gauge.

6. The storage tank of claim 5 including a cover on said sleeve, and a window in said cover for viewing the gauge.
